(19) United States
(12) Patent Application Publication
(10) Pub. No.: US 2010/0096513 A1
(43) Pub. Date: Apr. 22, 2010

(54) Pool vacuum hose clip/ lane buoy clip

(76) Inventor: Frank Denis Beebe, Anaheim, CA (US)

Correspondence Address: Frank Denis Beebe, 9601 Hillview Rd., Anaheim, CA, 92804, US

(21) Appl. No.: 12/231,034

(22) Filed: Oct. 22, 2008

(51) Int. Cl. F16L 3/00

(52) U.S. Cl. 248/75

(57) ABSTRACT

A removable vacuum hose/lane buoy clip system that is attached to the sides of a pool by suction cup and can be positioned anywhere on the wall of the pool. There are no permanent features attached to the pool deck or side surface. When the clip system is suctioned to the side of the pool, it can then clip onto the vacuum hose and prevent the hose from moving around the pool or can clip onto lane buoys to section off any part of a pool. The hooks when not in use, can easily be removed and stored away elsewhere

### FIELD OF INVENTION

The present invention relates to a removable pool vacuum hose/lane buoy clip system.

### DESCRIPTION OF THE PRIOR ART

The use of a pool sweeper hose clamp is known in the prior art. By way of example, U.S. Pat. No. 5,110,075 discloses a clamp assembly mounted against the wall of a swimming pool which folds back into its mounting base plate when not in use.

In this respect, the removable pool vacuum hose/lane buoy clip system of the present invention substantially departs from the conventional concepts and designs of the prior art, and in so doing provides a clip system that can be positioned anywhere on the pool wall and can be removed entirely when not in use.

Therefore, it can be appreciated that there exists a continuing need for an improved pool hose clip system. In this regard, the present invention substantially fulfills this need.

### SUMMARY OF THE INVENTION

In view of the foregoing disadvantages inherent in the known type of the pool sweeper hose clamp now present in the prior art, the present invention provides a removable vacuum hose/lane buoy clip which can readily be attached to the side walls of the pool wall by suction cup and can be positioned anywhere on the wall of the pool. As such, the general purpose of the present invention is to provide a clip system to hold a pool vacuum hose in place along the side of the pool, or to clip a lane buoy to section off any part of a pool. To attain this, the present invention essentially comprises a pool vacuum hose/lane buoy clip system. The system includes an outer body assembly with suction cup and is interconnected to a hose clip.

There has thus been outlined, rather broadly, the more important features of the invention in order that the detailed description there of that follows may be better understood, and in order that the present contribution to the art may be better appreciated.

### DETAILED DESCRIPTION

The present invention provides a new and improved pool vacuum hose/lane buoy clip system comprising a suction cup body formed from plastic and including an external suction cup formed from rubber. A hook clip is secured on the bottom surface of the plastic suction cup body.

An even further object of the present invention is to provide a pool vacuum hose/lane buoy clip system which is susceptible of a low cost of manufacture with regard to both materials and labor, and which accordingly is then susceptible of low prices of sale to the consuming public, thereby making such suction clips economically available to the buying public.

Still yet another object of the present invention is to provide a pool vacuum hose/lane buoy clip system which provides in the apparatuses of the prior art some of the advantages thereof, while simultaneously overcoming some of the disadvantages normally associated therewith.

These together with other objects of the invention, along with the various features of novelty which characterize the invention are pointed out with particularity in the claims annexed to and forming a part of this disclosure.

### DESCRIPTION OF DRAWINGS

FIG. 1 a side elevation view of the pool vacuum hose/lane buoy clip system of the present invention employing a metal hook.

FIG. 2 is a front elevation view of the pool vacuum hose/lane buoy clip system of the present invention.

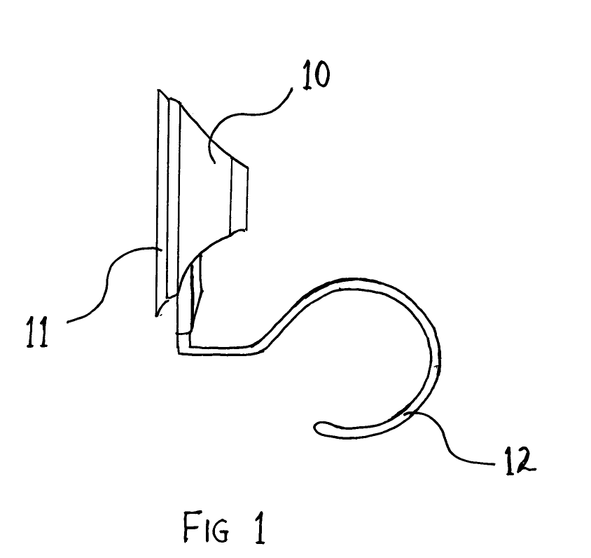

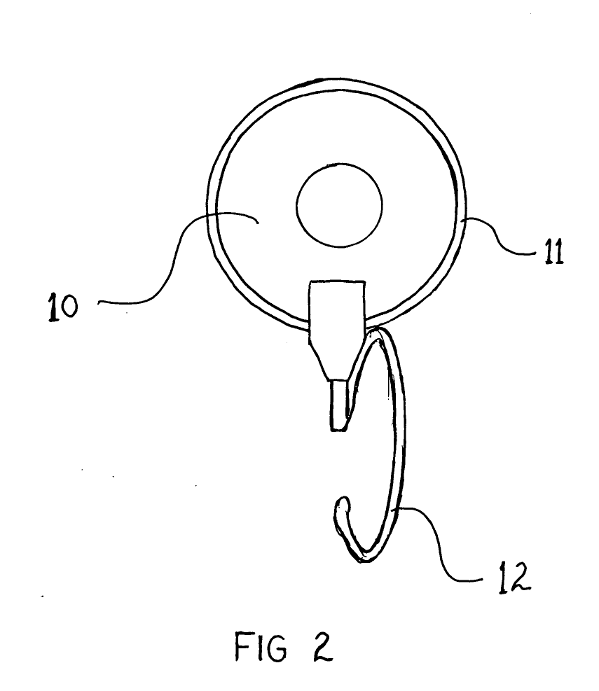

The present invention relates to a pool vacuum hose/lane buoy clip system. With reference to FIG. 1 and FIG. 2, the suction cup body 10 of the present invention is formed from a rigid plastic and includes an external suction cup 11 formed from rugged rubber material. A hook assembly 12 of the present invention is formed from a rust resistant metal and attached to the bottom portion of the suction cup body 10.

### DESCRIPTION OF PREFERRED EMBODIMENT

The present invention is a pool vacuum hose/lane buoy clip system. It is comprised of a suction cup body, external suction cup, and a hook assembly. All components are produced from rigid plastic, metal, or rugged rubberized material. The rubber suction cup is designed to stick to any section of the pool side wall, while the metal hook assembly is designed to hold the vacuum hose or lane buoy in a desired position. It is not desired to limit the invention to the exact construction and operation shown and described, and accordingly, all suitable modifications and equivalents may be resorted to, falling within the scope of the invention.

What is claimed as being new and desired to be protected by patent:

1. A new and improved vacuum hose/lane buoy clip system comprising in combination: A suction cup body formed from a rigid plastic and including an external suction cup formed from a rugged rubber material

2. A hook assembly formed from a rust resistant metal and is attached to the bottom section of the plastic suction cup body.

3. The suction cup body is formed form a rigid plastic and is round in shape.

4. The external suction cup is formed from a rugged rubber material and is round in shape

5. The hook assembly is formed from a rust resistant metal and has a half round profile for connection with a vacuum hose or lane buoy line when in use.
